(19) United States
(12) Patent Application Publication
(10) Pub. No.: US 2025/0346787 A1
(43) Pub. Date: Nov. 13, 2025

(54) REUSABLE ELECTRO-TRIGGERED DEBONDING ADHESIVE TAPE WITH HIGH SHEAR STRENGTH AND PREPARATION METHOD THEREOF

(71) Applicant: BYE POLYMER MATERIAL CO., LTD, Suzhou (CN)

(72) Inventor: Sihai YU, Suzhou (CN)

(21) Appl. No.: 19/247,957

(22) Filed: Jun. 24, 2025

Related U.S. Application Data
(63) Continuation of application No. PCT/CN2025/080597, filed on Mar. 5, 2025.

(30) Foreign Application Priority Data
May 11, 2024 (CN) 202410582477.9

(51) Int. Cl. C09J 7/30; C08K 3/32; C08K 5/09; C08K 5/103; C08K 5/1565; C08K 5/32; C09J 133/08; C09J 171/08

(52) U.S. Cl. CPC C09J 7/30; C08K 5/09; C08K 5/103; C08K 5/1565; C08K 5/32; C09J 133/08; C09J 171/08; C08K 2003/324; C09J 2301/502

(57) ABSTRACT

A reusable electro-triggered debonding adhesive tape with a high shear strength and a preparation method thereof are provided, relating to the technical field of adhesive materials. It is prepared by adopting an acrylate or olefin monomer, an ester containing methoxy polyethylene glycol, an acrylic acid compound, a salt, a functional monomer, an organic solvent, a tackifying resins, etc. The electro-triggered debonding adhesive tape has most of the electrolyte chemically bonded on a molecular chain of a main adhesive, and a portion of the electrolyte is dissociated and complexed by the strong ether-oxygen bond in methoxy polyethylene glycol, instead of simple physical blending. Therefore, a large amount of electrolyte is effectively prevented from being precipitated when the electrolyte is electrified while enabling reusability.

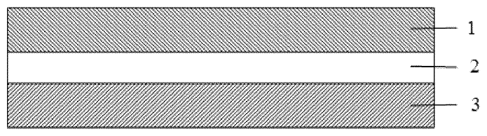

### TECHNICAL FIELD

The disclosure relates to the technical field of adhesive materials, and more particularly to a reusable electro-triggered debonding adhesive tape with a high shear strength and a preparation method thereof.

### BACKGROUND

Electro-triggered debonding adhesive in the related art is mainly prepared by physical blending of adhesive resin, inert organic solvent and salt (or ionic liquid).

The fundamental principle of electro-triggered debonding (also referred to as electrification stickiness reduction) is that an electrolyte, composed of molten salt alone or molten salt combined with an inert solvent, migrates towards an electrode under a drive of an electric field. The electrolyte concentration near the electrode, particularly at a surface of an adhesive layer, increases significantly, even precipitate onto the surface of the electrode. This disrupts the original van der Waals forces between the adhesive resin and the electrode. Additionally, redox reactions occurring between the electrolyte and the electrode, leading to a reduction in adhesion.

In the related art, the electrolyte composed of the inert solvent and the salt or the ionic liquid exhibits favorable electro-triggered debonding functionality, However, due to its low molecular weight, it exerts an excessively strong plasticizing effect on the adhesive system, leading to a reduction in the bulk strength of the adhesive layer and a decrease in shear strength. Additionally, the electrolyte tends to precipitate after electrification, resulting in the loss of functional components and a decline in reversibility.

For example, as disclosed in a Chinese patent application CN115895519A, an electrolytic adhesive and a double-sided tape are prepared by physically mixing an adhesive main body, a solid conductive salt and a polar proton inert solvent. However, they suffer from severe precipitation after electrification, which contaminates an adherend; exhibit poor reusability; and face issues such as a high addition amount of the inert solvent and the salt (or the ionic liquid), leading to low colloidal shear strength.

In addition, Nitto Denko Corporation disclosed in a patent application CN116656256A that an electrically peelable adhesive composition achieves favorable electro-triggered debonding performance at a relatively low applied voltage (10 volts, abbreviated as V) within a short duration (30 seconds, abbreviated as s). However, its initial peeling force is low, only 3.35 newtons per centimeter (N/cm). In a patent application CN118043424A, the initial peeling force is improved, which can reach 25 N per 25 millimeters (mm), and the electro-triggered debonding performance under elevated temperature and humidity conditions is improved, but its shear strength and reversibility have not been reported.

### SUMMARY

In view of the above shortcomings in the related art, the disclosure provides a reusable electro-triggered debonding adhesive tape with a high shear strength and a preparation method thereof, which can effectively solve the above problems in the related art.

Technical solutions are as follows.

In order to achieve the above objectives, the disclosure is realized by the following technical solutions.

In an aspect, the disclosure provides an electro-triggered debonding liquid, including: an acrylate or olefin monomer, an ester containing methoxy polyethylene glycol, and a functional monomer.

In an embodiment, the electro-triggered debonding liquid further includes an organic solvent, a tackifying resin, an acrylic acid compound, an initiator, and an aqueous solution containing lithium (Li) or sodium (Na) ions. Specifically, the aqueous solution containing Li or Na ions is an aqueous solution of lithium hydroxide or sodium hydroxide.

In an embodiment, the acrylate or olefin monomer includes one or more selected from the group consisting of methyl acrylate, methyl methacrylate, ethyl acrylate, butyl acrylate, 2-ethylhexyl acrylate, decyl acrylate, cyclohexyl acrylate, isobornyl acrylate, acrylonitrile, styrene, vinyl acetate, polyurethane acrylate oligomer, polyester acrylate oligomer, epoxy polyacrylate oligomer, ethoxylated phenoxy acrylate, o-phenylphenoxy ethyl acrylate, 2-(p-isopropylphenyl-phenoxy)-ethyl acrylate, nonylphenol polyoxyethylene ether acrylate, and ethyl ethoxyhexyl ester acrylate.

The ester containing methoxy polyethylene glycol is methoxy polyethylene glycol monoacrylate; and a molecular weight of polyethylene glycol in the methoxy polyethylene glycol monoacrylate is in a range of 100-2000.

The acrylic acid compound includes at least one or two of methacrylic acid and acrylic acid.

In an embodiment, the functional monomer is an acrylic acid and an acrylate containing a carboxyl group, a hydroxyl group, an epoxy group, or an amine group.

Specifically, the functional monomer includes one or more selected from the group consisting of acrylic acid, hydroxypropyl acrylate, hydroxyethyl acrylate, hydroxyethyl methacrylate, hydroxypropyl methacrylate, glycidyl methacrylate, and acrylamide.

In an embodiment, the organic solvent includes one or two selected from the group consisting of a high-boiling organic solvent and a low-boiling organic solvent.

The high-boiling solvent refers to a solvent with a boiling point greater than 150° C. The high-boiling organic solvent one or more selected from the group consisting of propylene carbonate, ethylene carbonate, vinylene carbonate, γ-butyrolactone, dimethyl sulfone, diphenyl sulfone, and sulfolane.

The low boiling point solvent refers to a solvent with a boiling point less than or equal to 150° C. The low-boiling organic solvent includes one or more selected from the group consisting of toluene, benzene, xylene, pentane, hexane, octane, heptane, cyclohexane, acetone, methyl butyl ketone, methyl isobutyl ketone, methanol, ethanol, isopropanol, diethyl ether, propylene oxide, methyl acetate, ethyl acetate, propyl acetate, and butyl acetate.

In an embodiment, the electro-triggered debonding liquid further includes a salt. The salt includes one or more selected from the group consisting of lithium tetrafluoroborate (LiBF₄), lithium bis(trifluoromethylsulfonyl)imide (LiTFSI), lithium perchlorate (LiClO₄), lithium hexafluoroarsenate (LiAsF₆), lithium hexafluorophosphate (LiPF₆), lithium trifluoromethylsulfonate (LiCF₃SO₃), lithium bis(oxalato)borate (LiBOB), sodium perchlorate, sodium tetrafluoroborate, sodium thiocyanate, sodium hexafluorophosphate (NaPF₆), sodium bis(trifluoromethylsulfonyl)imide (NaTFSI), and sodium trifluoromethylsulfonate (NaCF₃SO₃).

The tackifying resin includes one or more selected from the group consisting of maleic rosin, terpene resin, terpene phenolic resin, hydrogenated rosin, rosin glycerol ester, C5 petroleum resin, and C7 petroleum resin.

The initiator includes one or more selected from the group consisting of lauroyl peroxide, benzoyl peroxide, tert-butyl peroxide pivalate, cumene hydroperoxide, azobisisobutyronitrile, and azobisisoheptonitrile.

In an embodiment, the electro-triggered debonding liquid includes, in parts by weight, 30-75 parts of the acrylate or olefin monomer, 10-30 parts of methoxy polyethylene glycol monoacrylate, 2-20 parts of the acrylic acid compound, 2-15 parts of the high-boiling organic solvent, 2-15 parts of the salt, 2-10 parts of the functional monomer of acrylic acid and acrylate, 50-100 parts of the low-boiling organic solvent, 0.1-10 parts of the tackifying resin, 0.1-1.5 parts of the initiator, and 1-5 parts of the aqueous solution containing Li or Na ions.

In a specifical embodiment, the electro-triggered debonding liquid includes, in parts by weight, 60-70 parts of the acrylate or olefin monomer, 12-18 parts of methoxy polyethylene glycol monoacrylate, 2-8 parts of the acrylic acid compound, 2-8 parts of the high-boiling organic solvent, 2-8 parts of the salt, 2-8 parts of the functional monomer of acrylic acid and acrylate, 80-100 parts of the low-boiling organic solvent, 0.1-8 parts of the tackifying resin, 0.1-0.5 parts of the initiator, and 1-5 parts of the aqueous solution containing Li or Na ions. Specifically, the aqueous solution containing Li or Na ions is an aqueous solution of lithium hydroxide or sodium hydroxide with a concentration of 40-60%. More specifically, the aqueous solution containing Li or Na ions is an aqueous solution of lithium hydroxide or sodium hydroxide with a concentration of 50%.

In a more specifical embodiment, the electro-triggered debonding liquid includes, in parts by weight, 65 parts of the acrylate or olefin monomer, 15 parts of methoxy polyethylene glycol monoacrylate, 5 parts of the acrylic acid compound, 5 parts of the high-boiling organic solvent, 5 parts of the salt, 5 parts of the functional monomer of acrylic acid and acrylate, 100 parts of the low-boiling organic solvent, 5 parts of the tackifying resin, 0.3 parts of the initiator, and 2 parts of the aqueous solution containing Li or Na ions.

In another aspect, the disclosure provides an electro-triggered debonding adhesive is prepared by adding a crosslinking agent into the electro-triggered debonding liquid.

In an embodiment, the electro-triggered debonding adhesive is prepared by further adding a catalyst to the electro-triggered debonding liquid.

Specifically, the crosslinking agent includes one or more selected from the group consisting of diphenylmethane diisocyanate (MDI), hexamethylene diisocyanate (HDI), toluene diisocyanate (TDI), isophorone diisocyanate (IPDI), dicyclohexylmethane diisocyanate (HMDI), lysine diisocyanate (LDI), TDI-trimethylolpropane adduct, IPDI trimer, biuret polyisocyanate, HDI trimer, trifunctional aziridine, ethylenediamine, hexamethylenediamine, diethylenetriamine, triethylenetetramine, trimethylolpropane triglycidyl ether, isophoronediamine, m-phenylenediamine, and 2-ethyl-4-methylimidazole.

The catalyst includes one or more selected from the group consisting of stannous octoate, dibutyltin dilaurate, triethylenediamine, triethylamine, N,N-dimethylbenzylamine, N,N-dimethylhexadecylamine, and N,N-dimethylbutylamine.

In a specifical embodiment, 0.1-0.5 parts of the crosslinking agent and 0.01-0.05 parts of the catalyst are added to every 100 parts of the synthesized electro-triggered debonding liquid.

In a more specifical embodiment, 0.3 parts of the crosslinking agent and 0.02 parts of the catalyst are added to every 100 parts of the synthesized electro-triggered debonding liquid.

In still another aspect, an electro-triggered debonding adhesive tape is prepared by the electro-triggered debonding adhesive. Specifically, the electro-triggered debonding adhesive is coated on a release liner I, dried and compounded with a release liner II, and then rolled and cured. More specifically, the release liner I and the release liner II are made of polyethylene (PE), polypropylene (PP), or polyethylene terephthalate (PET).

In an embodiment, a release force difference between the release liner I and the release liner II is greater than or equal to 5 gram-force per 25 millimeters (5 gf/25 mm).

In even still another aspect, the disclosure relates to a preparation method of the electro-triggered debonding adhesive tape, which including the following steps:
S1, synthesizing the electro-triggered debonding liquid, including: adding materials including the acrylate or olefin monomer, the ester containing methoxy polyethylene glycol, an acrylic acid compound, a salt, the functional monomer, an organic solvent and a tackifying resin into a reaction kettle, uniformly stirring the materials, introducing nitrogen to discharge oxygen in the reaction kettle and the materials, heating while stirring, adding a portion of an initiator when a temperature of the materials in the reaction kettle rises to 50-70° C., and then heating to 70-80° C. and commencing timing a reaction, reacting for 3-6 hours, then supplementing a remaining portion of the initiator and continuing reacting for 1-3 hours; cooling to 35-45° C., adding a 50% aqueous solution containing Li or Na ions into the reaction kettle to obtain a mixed solution, stirring the mixed solution for 10-30 minutes to obtain the electro-triggered debonding liquid, and discharging the electro-triggered debonding liquid for later use;
S2, preparing the electro-triggered debonding adhesive, including: adding the crosslinking agent and the catalyst into the electro-triggered debonding liquid synthesized in the step S1 to obtain a mixture, uniformly stirring the mixture to obtain the electro-triggered debonding adhesive, and storing the electro-triggered debonding adhesive below 20-30° C. for later use; and
S3, preparing the electro-triggered debonding adhesive tape, including: coating the electro-triggered debonding adhesive tape prepared in the step S2 on the release liner I to obtain a coated product, baking the coated product in an oven at 70-90° C. for 1-4 minutes to obtain a baked product, compounding the baked product with the release liner II to obtain a compounded product, and curing the compounded product at 30-50° C. for 24-72 hours, thus obtaining the electro-triggered debonding adhesive tape protected by double-sided release liners.

In an embodiment, the preparation method of the electro-triggered debonding adhesive tape includes the following steps:
S1: synthesizing the electro-triggered debonding liquid, including: adding materials including 30-75 parts of the acrylate or olefin monomer, 10-30 parts of methoxy polyethylene glycol monoacrylate, 2-20 parts of methacrylic acid, 2-15 parts of the high-boiling organic solvent, 2-15 parts of salt, 2-10 parts of the functional monomer of an acrylic acid and an acrylate containing a carboxyl group, a hydroxyl group, an epoxy group, or an amine group, 50-100 parts of the low-boiling organic solvent, and 0.1-10 parts of tackifying resin into the reaction kettle, uniformly stirring the materials, introducing a non-oxygen inert gas to discharge oxygen in the reaction kettle and the materials, maintaining a certain pressure, heating while stirring, adding 0.1-1 part of the initiator when a temperature of the materials in the reaction kettle rises to 60° C., and then heating to 70-80° C. and commencing timing a reaction, reacting for 4-5 hours, then supplementing 0.05-0.5 parts of the initiator and continuing reacting for 2 hours; cooling to 35-45° C., adding 1-5 parts of the 50% aqueous solution of lithium hydroxide or sodium hydroxide into the reaction kettle to obtain a mixed solution, stirring the mixed solution for 20 minutes to obtain the electro-triggered debonding liquid, and discharging the electro-triggered debonding liquid for later use, with a viscosity of the materials in range of 400 to 20000 centipoises (cps);
S2, preparing the electro-triggered debonding adhesive, including: adding 0.2-20 parts of the crosslinking agent and 0.05-0.2 parts of the catalyst into 100 parts of the electro-triggered debonding liquid synthesized in the step S1 to obtain a mixture, uniformly stirring the mixture to obtain the electro-triggered debonding adhesive, and storing the electro-triggered debonding adhesive below 25° C. for 1-6 hours for later use; and
S3, preparing the electro-triggered debonding adhesive tape, including: coating the electro-triggered debonding adhesive tape prepared in the step S2 on the release liner I with a thickness of 5-100 micrometers (μm) to obtain a coated product, baking the coated product in an oven at 50-90° C. for 0.5-2 minutes to obtain a baked product, compounding the baked product with the release liner II with a thickness of 5-100 μm to obtain a compounded product, and curing the compounded product at 30-50° C. for 24-72 hours, thus obtaining the electro-triggered debonding adhesive tape protected by double-sided release liners. A thickness of an electrolyte membrane sheet is 10-200 μm, and its structure is shown in attached the FIGURE.

According to the disclosure, the methoxy polyethylene glycol with salt solubility is polymerized into a molecular chain of the adhesive, which not only has the ability to promote migration of salt under voltage, but also avoids the defect that the high-boiling solvent is easy to precipitate. In addition, the methoxy polyethylene glycol is intrinsically polymerized on the molecular chain, unlike internally added low-molecular-weight substances, it does not compromise the mechanical properties of the adhesive colloid.

### Beneficial Effects

Compared with the related art, the technical solutions provided by the disclosure has the following beneficial effects.

According to the electro-triggered debonding adhesive of the embodiment of the disclosure, most of the electrolyte is chemically bonded to the molecular chain of the main adhesive, and part of the electrolyte is dissociated and complexed by the strong ether-oxygen bond in methoxy polyethylene glycol, instead of simple physical blending in the related art. Therefore, a large amount of electrolyte is effectively prevented from being precipitated when the electrolyte is electrified while enabling reusability. In addition, the bulk strength of the adhesive is also improved, showing a superior shear strength.

### BRIEF DESCRIPTION OF DRAWINGS

In order to explain technical solutions in embodiments of the disclosure or the related art more clearly, the drawings needed in the description of the embodiments or the related art will be briefly introduced below. Apparently, the drawings in the following description are only some embodiments of the disclosure, and other drawings can be obtained according to these drawings without creative work for those skilled in the art.

FIGURE illustrates a schematic structural diagram of an electro-triggered debonding adhesive tape of the disclosure.

### DESCRIPTIONS OF REFERENCE SIGNS

1—release liner I, 2—adhesive layer, and 3—release liner II.

### DETAILED DESCRIPTION OF EMBODIMENTS

In order to make purposes, technical solutions and advantages of embodiments of the disclosure clearer, the technical solutions in the embodiments of the disclosure will be described clearly and completely with the accompanying drawings. Apparently, the described embodiments are some of the embodiments of the disclosure, not the whole embodiment. Based on the embodiments in the disclosure, all other embodiments obtained by those skilled in the art without creative work belong to the scope of protection of the disclosure.

The disclosure will be further described with the embodiments.

### (1) Preparation of Electro-Triggered Debonding Adhesive Tape

### Embodiment 1

Step A: synthesis of electro-triggered debonding liquid. Specifically, materials including 30 parts of 2-ethylhexyl acrylate, 20 parts of butyl acrylate, 15 parts of methyl methacrylate, 15 parts of methoxy polyethylene glycol (molecular weight: 600) monoacrylate, 5 parts of acrylic acid, 5 parts of propylene carbonate, 5 parts of LiPF₆, 5 parts of hydroxyethyl acrylate, 5 parts of rosin glycerol ester, and 100 parts of ethyl acetate are added into a reaction kettle, stirred uniformly, and nitrogen is introduced to exhaust oxygen in the reaction kettle and the materials. The reaction kettle is kept at a certain pressure, with continuous stirring, the temperature is raised until the temperature of the materials in the reaction kettle rises to 60° C., 0.2 parts of dibenzoyl peroxide are added, and then the temperature is raised to 75° C. to start the timed reaction for 4 hours. Then, 0.1 parts of dibenzoyl peroxide are added to continue the reaction for 2 hours, cooled to 35° C.-45° C., 2 parts of 50% concentration lithium hydroxide aqueous solution are added, and stirred for 20 minutes. The electro-triggered debonding liquid is discharged for later use, with a viscosity of the materials in a range of 4000 to 10000 cps.

Step B: preparation of electro-triggered debonding adhesive. Specifically, 0.3 parts of HDI trimer and 0.02 parts of dibutyltin dilaurate are added into 100 parts of synthesized electro-triggered debonding liquid, stirred evenly, and stored below 25° C. for later use.

Step C: preparation of electro-triggered debonding adhesive tape. Specifically, the prepared electro-triggered debonding adhesive is coated on a release liner I with a thickness of 50 μm, baked in an oven at 80° C. for 3 minutes, compounded with a release liner II with a thickness of 25 μm, and cured at 40° C. for 48 hours to obtain the electro-triggered debonding adhesive tape protected by double-sided release liners. A thickness of an electrolyte membrane sheet (i.e., adhesive layer) is 50 μm, and its structure is shown in attached the FIGURE.

### Embodiment 2

Step A: synthesis of electro-triggered debonding liquid. Specifically, materials including 20 parts of 2-ethylhexyl acrylate, 30 parts of butyl acrylate, 10 parts of styrene, 20 parts of methoxy polyethylene glycol (molecular weight: 1000) monoacrylate, 5 parts of acrylic acid, 5 parts of propylene carbonate, 5 parts of LiPF₆, 5 parts of hydroxyethyl methacrylate, 5 parts of terpene resin and 100 parts of ethyl acetate are added into a reaction kettle, stirred uniformly, and nitrogen is introduced to discharge oxygen in the reaction kettle and the materials. The reaction kettle is kept at a certain pressure, with continuous stirring, the temperature is raised until the temperature of the materials in the reaction kettle rises to 60° C., 0.2 parts of dibenzoyl peroxide are added, and then the temperature is raised to 75° C. to start the timed reaction for 4 hours. Then, 0.1 parts of dibenzoyl peroxide are added to continue the reaction for 2 hours, cooled to 35° C.-45° C. The electro-triggered debonding liquid is discharged for later use, with a viscosity of the materials in a range of 4000 to 10000 cps.

Step B: preparation of electro-triggered debonding adhesive. Specifically, 0.4 parts of trifunctional aziridine are added into 100 parts of synthesized electro-triggered debonding liquid, and stored below 25° C. for later use.

Step C: the same as the step C of the embodiment 1.

### Embodiment 3

Step A: the same as the step A of the embodiment 1, 5 parts of glycidyl methacrylate is used instead of 5 parts of hydroxyethyl acrylate.

Step B: preparation of electro-triggered debonding adhesive. Specifically, 0.3 parts of isophoronediamine are added into 100 parts of synthesized electro-triggered debonding liquid, and evenly stirred and stored below 25° C. for later use.

Step C: the same as step C in the embodiment 1.

### Embodiment 4

Step A: the same as the step A of the embodiment 1, 5 parts of NaPF₆ is used to replace 5 parts of LiPF₆.

Step B: the same as the step B in the embodiment 1;

Step B: the same as the step C in the embodiment 1.

### Comparative Embodiment 1

100 parts of Shimei Chemical PS-8281E2 solvent-based acrylic pressure-sensitive adhesive (49% solids content) is taken. 20 parts of LiPF₆, 20 parts of propylene carbonate, 10 parts of Shimei Chemical PX2300A curing agent, 10 parts of terpene resin, 50 parts of ethyl acetate, and 50 parts of toluene are added, stirred, and homogenously dispersed. Subsequently, an electro-triggered debonding adhesive tape with 50 μm-thick electrolyte membranes is prepared according to the procedure described in the step C of the embodiment 1.

### Comparative Embodiment 2

Step A: the same as the step A in the embodiment 1, except that 15 parts of methoxy polyethylene glycol (molecular weight: 600) monoacrylate are not added.

Step B: the same as the step B in the embodiment 1.

Step C: the same as the step C in the embodiment 1.

### Comparative Embodiment 3

Step A: the same as the step A in the embodiment 1, except that 5 parts of hydroxyethyl acrylate are not added.

Step B: the same as the step B in the embodiment 1, except that 0.3 part of HDI trimer and 0.02 part of dibutyltin dilaurate are not added.

Step C: the same as the step C in the embodiment 1.

### Comparative Embodiment 4

Step A: the same as the step A of the embodiment 1, except that 5 parts of acrylic acid are not added.

Step B: the same as the step B in the embodiment 1.

Step C: the same as the step C in the embodiment 1.

### Comparative Embodiment 5

Step A: the same as the step A of the embodiment 1, except that 5 parts of propylene carbonate are not added.

Step B: the same as the step B in the embodiment 1.

Step C: the same as the step C in the embodiment 1.

### (2) Performance Test

Performance testing is conducted on the electro-triggered debonding adhesive tapes obtained from the embodiments 1-4 and the comparative embodiments 1-5 as follows.

(1) Surface resistance testing (GB/T 1410-2006): one release liner is removed from the electro-triggered debonding adhesive tape, and surface resistance is measured on the exposed adhesive surface.

(2) 180° peeling force testing (GB/T 2792-2014): \textcircled{1} Measurement before electrification: after removal of one release liner, the electro-triggered debonding adhesive tape is laminated onto a steel plate, three rounds are applied with a 2 kilograms (kg) rubber roller. The peeling force is measured after 24 hours at 23° C. and recorded as F1. \textcircled{2} Measurement after electrification: the electro-triggered debonding adhesive tape is laminated onto aluminum foil (one release liner removed) with three rounds of the 2 kg rubber roller. The opposite release liner is then removed and laminated onto a steel plate with rounds of a 2 kg rubber roller, and placed at 23° C. for 24 hours. Then, a positive electrode of a direct-current (DC) power supply is connected to the aluminum foil, and a negative electrode of the DC power supply is connected to the steel plate. Samples are subjected to 30 V*30 s of electrification, and then the 180° peeling force is tested and recorded as F2.

(3) Shear strength testing (GB/T 7124-2008): the electro-triggered debonding adhesive tape is torn off the release liner and attached to an aluminum plate substrate, and the other side of the release liner is torn off and attached to another aluminum sheet. A bonding area is 12.5*25 mm, and the shear force is tested after 20 minutes.

(4) Peeling force reversibility testing: samples from the 180° peeling force testing are re-attracted onto a new steel plate with three rounds of the 2 kg rubber roller, and placed at 23° C. for 24 hours, the peeling force is measured and recorded asre-attachment peeling force F3. The recovery ratio W (%) is calculated as: W=(F3/F1)×100%

(5) Residual testing on a surface of the steel plate after electrification peeling: the surface contamination of the steel plate after the electrification peeling force test is observed, and whether there is oil or residual glue.

TABLE 1

| | | | | | Re- | | |
|---|---|---|---|---|---|---|---|
| | | | | Peeling force | adhesion | | Residual |
| | surface | shear | Peeling | after | peeling | Peeling force | situation after |
| | resistance | force | force F1 | electrification | force F3 | recovery ratio | electrification |
| Sample | (Ω) | (MPa) | (g/25 mm) | F2 (g/25 mm) | (g/25 mm) | (F3/F1*100%) | peeling |
| Embodiment | 10⁸ | 1.2 | 2518 | 26 | 2491 | 98.93% | No oil pollution, |
| 1 | | | | | | | no residual glue |
| Embodiment | 10⁸ | 1.3 | 2933 | 49 | 2791 | 95.16% | No oil pollution, |
| 2 | | | | | | | no residual glue |
| Embodiment | 10⁸ | 1.3 | 2811 | 37 | 2692 | 95.77% | No oil pollution, |
| 3 | | | | | | | no residual glue |
| Embodiment | 10⁸ | 1.5 | 2850 | 171 | 2394 | 84% | No oil pollution, |
| 4 | | | | | | | no residual glue |
| Comparative | 10⁷ | 0.7 | 1845 | 17 | 1298 | 70.35% | Obvious oil |
| embodiment | | | | | | | pollution |
| 1 | | | | | | | |
| Comparative | 10⁷ | 0.5 | 1637 | 12 | 932 | 56.93% | Obvious oil |
| embodiment | | | | | | | pollution |
| 2 | | | | | | | |
| Comparative | 10⁷ | 0.3 | 2012 | 38 | 1367 | 67.94% | Residual glue |
| embodiment | | | | | | | |
| 3 | | | | | | | |
| Comparative | 10⁷ | 0.7 | 762 | 13 | 714 | 93.70% | No oil pollution, |
| embodiment | | | | | | | no residual glue |
| 4 | | | | | | | |
| Comparative | 10⁸ | 1.5 | 3032 | 878 | 2846 | 93.87% | No oil pollution, |
| embodiment | | | | | | | no residual glue |
| 5 | | | | | | | |

Comparative data in Table 1 can be obtained by testing embodiments and comparative embodiments. From the data in Table 1, it can be seen that the electro-triggered debonding adhesive tape prepared in the embodiment 1 has higher shear strength and better peeling force recovery ability after electrification. However, the peeling force recovery ability of the adhesive tapes in the comparative embodiments is relatively poor, especially for the adhesive tapes prepared by the lack of methoxy polyethylene glycol (molecular weight: 600) monoacrylate or the functional monomer and the crosslinking agent, the peeling force recovery ratio is less than 70%.

In addition, if lithium salt is used in the electro-triggered debonding liquid, as in the embodiments 1-3, the electro-triggered debonding adhesive tape prepared by the electro-triggered debonding liquid can be bonded again after electrification, and the peeling force recovery ratio is greater than 95%. However, if sodium salt is used in the electro-triggered debonding liquid, as in the embodiment 4, the electro-triggered debonding adhesive tape prepared by the electro-triggered debonding liquid can be bonded again after electrification, and the peeling force recovery ratio can also reach 84%.

According to the electro-triggered debonding adhesive of the embodiment of the disclosure, most of the electrolyte is chemically bonded to the molecular chain of the main adhesive, and part of the electrolyte is dissociated and complexed by the strong ether-oxygen bond in methoxy polyethylene glycol, instead of simple physical blending in the related art. Therefore, a large amount of electrolyte is effectively prevented from being precipitated when the electrolyte is electrified while enabling reusability. In addition, the bulk strength of the adhesive is also improved, showing a superior shear strength.

The above embodiments are only used to illustrate the technical solutions of the disclosure, but not to limit it. Although the disclosure has been described in detail with reference to the foregoing embodiments, those skilled in the art should understand that the technical solutions described in the foregoing embodiments can still be modified, or some of the technical features thereof can be equivalently replaced. These modifications or replacements will not cause the essence of the corresponding technical solutions to deviate from the protection scope of the technical solutions of the embodiments of the disclosure.

What is claimed is:

1. An electro-triggered debonding liquid, comprising: an acrylate or olefin monomer, an ester containing methoxy polyethylene glycol, and a functional monomer.

2. The electro-triggered debonding liquid as claimed in claim 1, further comprising: an organic solvent, a tackifying resin, an acrylic acid compound, an initiator, and an aqueous solution containing lithium (Li) or sodium (Na) ions; and
wherein the aqueous solution containing Li or Na ions is an aqueous solution of lithium hydroxide or sodium hydroxide.

3. The electro-triggered debonding liquid as claimed in claim 2, wherein:
the acrylate or olefin monomer comprises one or more selected from the group consisting of methyl acrylate, methyl methacrylate, ethyl acrylate, butyl acrylate, 2-ethylhexyl acrylate, decyl acrylate, cyclohexyl acrylate, isobornyl acrylate, acrylonitrile, styrene, vinyl acetate, polyurethane acrylate oligomer, polyester acrylate oligomer, epoxy polyacrylate oligomer, ethoxylated phenoxy acrylate, o-phenylphenoxy ethyl acrylate, 2-(p-isopropylphenyl-phenoxy)-ethyl acrylate, nonylphenol polyoxyethylene ether acrylate, and ethyl ethoxyhexyl ester acrylate;
the ester containing methoxy polyethylene glycol is methoxy polyethylene glycol monoacrylate; and a molecular weight of polyethylene glycol in the methoxy polyethylene glycol monoacrylate is in a range of 100-2000; and
the acrylic acid compound comprises at least one or two of methacrylic acid and acrylic acid.

4. The electro-triggered debonding liquid as claimed in claim 1, wherein the functional monomer is an acrylic acid and an acrylate containing a carboxyl group, a hydroxyl group, an epoxy group, or an amine group; and
wherein the functional monomer comprises one or more selected from the group consisting of acrylic acid, hydroxypropyl acrylate, hydroxyethyl acrylate, hydroxyethyl methacrylate, hydroxypropyl methacrylate, glycidyl methacrylate, and acrylamide.

5. The electro-triggered debonding liquid as claimed in claim 2, wherein the organic solvent comprises one or two selected from the group consisting of a high-boiling organic solvent and a low-boiling organic solvent;
the high-boiling organic solvent comprises one or more selected from the group consisting of propylene carbonate, ethylene carbonate, vinylene carbonate, γ-butyrolactone, dimethyl sulfone, diphenyl sulfone, and sulfolane; and
the low-boiling organic solvent comprises one or more selected from the group consisting of toluene, benzene, xylene, pentane, hexane, octane, heptane, cyclohexane, acetone, methyl butyl ketone, methyl isobutyl ketone, methanol, ethanol, isopropanol, diethyl ether, propylene oxide, methyl acetate, ethyl acetate, propyl acetate, and butyl acetate.

6. The electro-triggered debonding liquid as claimed in claim 5, further comprising a salt; wherein the salt comprises one or more selected from the group consisting of lithium tetrafluoroborate (LiBF₄), lithium bis(trifluoromethylsulfonyl)imide (LiTFSI), lithium perchlorate (LiClO₄), lithium hexafluoroarsenate (LiAsF₆), lithium hexafluorophosphate (LiPF₆), lithium trifluoromethylsulfonate (LiCF₃SO₃), lithium bis(oxalato)borate (LiBOB), sodium perchlorate, sodium tetrafluoroborate, sodium thiocyanate, sodium hexafluorophosphate (NaPF₆), sodium bis(trifluoromethylsulfonyl)imide (NaTFSI), and sodium trifluoromethylsulfonate (NaCF₃SO₃);
the tackifying resin comprises one or more selected from the group consisting of maleic rosin, terpene resin, terpene phenolic resin, hydrogenated rosin, rosin glycerol ester, C5 petroleum resin, and C7 petroleum resin; and
the initiator comprises one or more selected from the group consisting of lauroyl peroxide, benzoyl peroxide, tert-butyl peroxide pivalate, cumene hydroperoxide, azobisisobutyronitrile, and azobisisoheptonitrile.

7. The electro-triggered debonding liquid as claimed in claim 6, comprising, in parts by weight:
30-75 parts of the acrylate or olefin monomer,
10-30 parts of methoxy polyethylene glycol monoacrylate,
2-20 parts of the acrylic acid compound,
2-15 parts of the high-boiling organic solvent,
2-15 parts of the salt,
2-10 parts of the functional monomer of acrylic acid and acrylate,
50-100 parts of the low-boiling organic solvent,
0.1-10 parts of the tackifying resin,
0.1-1.5 parts of the initiator, and
1-5 parts of the aqueous solution containing Li or Na ions.

8. An electro-triggered debonding adhesive, prepared by adding a crosslinking agent to the electro-triggered debonding liquid as claimed in claim 1.

9. An electro-triggered debonding adhesive, prepared by adding a crosslinking agent to the electro-triggered debonding liquid as claimed in claim 2.

10. An electro-triggered debonding adhesive, prepared by adding a crosslinking agent to the electro-triggered debonding liquid as claimed in claim 3.

11. An electro-triggered debonding adhesive, prepared by adding a crosslinking agent to the electro-triggered debonding liquid as claimed in claim 4.

12. An electro-triggered debonding adhesive, prepared by adding a crosslinking agent to the electro-triggered debonding liquid as claimed in claim 5.

13. An electro-triggered debonding adhesive, prepared by adding a crosslinking agent to the electro-triggered debonding liquid as claimed in claim 6.

14. An electro-triggered debonding adhesive, prepared by adding a crosslinking agent to the electro-triggered debonding liquid as claimed in claim 7.

15. The electro-triggered debonding adhesive as claimed in claim 8, prepared by further adding a catalyst to the electro-triggered debonding liquid;
wherein the crosslinking agent comprises one or more selected from the group consisting of diphenylmethane diisocyanate (MDI), hexamethylene diisocyanate (HDI), toluene diisocyanate (TDI), isophorone diisocyanate (IPDI), dicyclohexylmethane diisocyanate (HMDI), lysine diisocyanate (LDI), TDI-trimethylolpropane adduct, IPDI trimer, biuret polyisocyanate, HDI trimer, trifunctional aziridine, ethylenediamine, hexamethylenediamine, diethylenetriamine, triethylenetetramine, trimethylolpropane triglycidyl ether, isophoronediamine, m-phenylenediamine, and 2-ethyl-4-methylimidazole; and
wherein the catalyst comprises one or more selected from the group consisting of stannous octoate, dibutyltin dilaurate, triethylenediamine, triethylamine, N,N-dimethylbenzylamine, N,N-dimethylhexadecylamine, and N,N-dimethylbutylamine.

16. An electro-triggered debonding adhesive tape, prepared by the electro-triggered debonding adhesive as claimed in claim 15;
wherein the electro-triggered debonding adhesive tape is prepared by coating the electro-triggered debonding adhesive on a release liner I, drying the release liner I coated the electro-triggered debonding adhesive, followed by compounding with a release liner II thereon, and then rolling and curing; and
wherein the release liner I and the release liner II are made of polyethylene (PE), polypropylene (PP), or polyethylene terephthalate (PET).

17. A preparation method of the electro-triggered debonding adhesive tape as claimed in claim 16, comprising the following steps:
S1, synthesizing the electro-triggered debonding liquid, comprising: adding materials including the acrylate or olefin monomer, the ester containing methoxy polyethylene glycol, an acrylic acid compound, a salt, the functional monomer, an organic solvent and a tackifying resin into a reaction kettle, uniformly stirring the materials, introducing nitrogen to discharge oxygen in the reaction kettle and the materials, heating while stirring, adding a portion of an initiator when a temperature of the materials in the reaction kettle rises to 50-70° C., and then heating to 70-80° C. and commencing timing a reaction, reacting for 3-6 hours, then supplementing a remaining portion of the initiator and continuing reacting for 1-3 hours; cooling to 35-45° C., adding a 50% aqueous solution containing Li or Na ions into the reaction kettle to obtain a mixed solution, stirring the mixed solution for 10-30 minutes to obtain the electro-triggered debonding liquid, and discharging the electro-triggered debonding liquid for later use;
S2, preparing the electro-triggered debonding adhesive, comprising: adding the crosslinking agent and the catalyst into the electro-triggered debonding liquid synthesized in the step S1 to obtain a mixture, uniformly stirring the mixture to obtain the electro-triggered debonding adhesive, and storing the electro-triggered debonding adhesive below 20-30° C. for later use; and
S3, preparing the electro-triggered debonding adhesive tape, comprising: coating the electro-triggered debonding adhesive tape prepared in the step S2 on the release liner I to obtain a coated product, baking the coated product in an oven at 70-90° C. for 1-4 minutes to obtain a baked product, compounding the baked product with the release liner II to obtain a compounded product, and curing the compounded product at 30-50° C. for 24-72 hours, thus obtaining the electro-triggered debonding adhesive tape protected by double-sided release liners.
